(19) United States
(12) Patent Application Publication
(10) Pub. No.: US 2011/0045448 A1
(43) Pub. Date: Feb. 24, 2011

(54) METHOD OF TEACHING READING AND SPELLING

(76) Inventor: David P. Hurford, Pittsburg, KS (US)

Correspondence Address: HUSCH BLACKWELL LLP, 4801 Main Street, Suite 1000, KANSAS CITY, MO, 64112, US

(21) Appl. No.: 12/545,640

(22) Filed: Aug. 21, 2009

(51) Int. Cl. G09B 1/00; G09B 17/00

(52) U.S. Cl. 434/172; 434/178

(57) ABSTRACT

A method of teaching reading and spelling is provided. The method includes the steps of presenting students with a set of letters and associating phonemes with each of the letters, presenting the students with at least one word that incorporates the phonemes, instructing the students to read the word by synthesizing the individual phonemes into the word, and then presenting the students with the names of the letters only after the students have learned substantially all of the phonemes associated with the letters. The method may also include the steps of providing the students with cards having the letters displayed thereon and then instructing the students to spell the word using the cards.

### CROSS-REFERENCE TO RELATED APPLICATIONS

None.

### BACKGROUND OF THE INVENTION

Learning to read and write are some of the most important and complex behaviors in which humans engage. In our culture, the social and economic success that a person enjoys is dependent, in part, upon the individual's ability to successfully learn to read and write. Today, approximately 15% to 20% of the children in the United States have difficultly learning to read and write. Unfortunately, this percentage is on the rise. This is due, in part, to the nature of the English language.

In transparent writing systems, each letter only represents one sound and each sound is only represented by one letter. However, the English language, which is influenced by a number of other languages including Anglo-Saxon, French, Latin, Greek and Danish, is not a transparent writing system.

Rather, in the English language, one letter may represent more than one sound. For example, this is the case with the letter “c” (which represents the /k/ and /s/ sounds), the letter “g” (which represents the /g/ and /j/ sounds), the letter “y” (which represents the /ē/ and /ī/ sounds), and all of the vowels (which also represent multiple sounds each).

Additionally, in the English language, one sound may be represented by more than one letter or combination of letters. For example, this is the case with the /k/ sound (which may be represented by the letter “c,” the letter “k,” and the combination of letters “ck”). Another example is the /e/ (which may be represented by the letters and combinations of letters “e,” “ee,” “ea,” “ey,” “y,” “ie,” and “i”).

The English language gets even more complicated when vowels are combined to form sounds. For example, the letter “o” and “i” (which already represent four sounds on their own—/\check{o}/, /ō/, /\check{i}/ and /ī/) can be combined to represent the /oi/ sound. To complicate the system even further, there are different spellings of words based on the words' context (e.g., “to,” “too,” and “two”).

Unfortunately, these idiosyncrasies of the English language cause it to be a very difficult language to learn. This often creates discouragement among students learning to read and write. Currently known methods for teaching reading and spelling do not adequately overcome these issues and a new method is therefore desirable.

Thus, a need exists for a method of teaching reading and spelling that addresses the difficulties and confusions that result in learning the English language. A need further exists for a method of teaching reading and spelling that presents students with the phonemes associated with each letter prior to teaching the students the actual names of the letters. A further need exists for a method of teaching reading wherein students are taught a process of decoding the letters contained in words into their respective phonemes and a method of teaching spelling wherein students are taught a process of encoding phonemes in to their respective letters in order to form words.

### SUMMARY OF THE INVENTION

The present invention involves the provision of a method of teaching reading and spelling. In one embodiment, the method includes the steps of presenting students with a set of letters and associating phonemes with each of the letters, presenting the students with at least one word that incorporates the phonemes, instructing the students to read the word by synthesizing the individual phonemes into the word, and then presenting the students with the names of the letters only after the students have learned substantially all of the phonemes associated with the letters. The method may also include the steps of providing the students with cards having the letters displayed thereon and then instructing the students to spell the word using the cards.

The method may be organized into a curriculum of lessons, which are intended to be presented at the rate of one lesson per day in the classroom setting. The students may be presented with an initial set of phonemes, which may be chosen based on their frequency of use in the English language and their utility in forming words. Once the students have been presented with the initial set of phonemes, they may be taught how to read and spell words incorporating those phonemes. Throughout the curriculum, the student are taught additional phonemes and how to read and spell words incorporating those additional phones.

Because the actual names of the letters can confuse the beginning reader, the actual names of the letters are not presented to the students until after the students have been presented with substantially all of the phonemes that are presented in the method.

Other and further objects of the invention, together with the features of novelty appurtenant thereto, will appear in the course of the following description.

### DESCRIPTION OF THE SEVERAL VIEWS OF THE DRAWINGS

In the accompanying drawings, which form a part of the specification and are to be read in conjunction therewith in which like reference numerals are used to indicate like or similar parts in the various views:

FIG. 1 is a list of phonemes of the English language taught to students in accordance with one embodiment of the present invention;

FIG. 2 is a table showing the lessons included in the method of teaching reading and spelling in accordance with one embodiment of the present invention;

FIG. 3 is a flow chart illustrating the basic steps included in the method of teaching reading and spelling in accordance with one embodiment of the present invention; and

FIG. 4 is a flow chart illustrating a more detailed set of steps included in the method of teaching reading and spelling in accordance with one embodiment of the present invention.

### DETAILED DESCRIPTION OF THE INVENTION

The present invention is directed generally to a method of teaching students to read and write opaque languages, such as the English language. At its core, the method makes a distinction between the phoneme(s) associated with each letter and the actual name of each letter. Phonemes are the distinct units of sound that are heard when a word is spoken, such as the /t/ in “train” and the /b/ in “blue.” Conversely, the actual name of each letter is the sound that is made when that letter is recited in the alphabet (e.g., the ABCs).

In the present invention, in order to avoid confusion, the students are taught the phoneme(s) associated with each letter before being taught the actual name of each letter. The letter names are not taught until the later stages of the method because letter name knowledge can confuse the beginning reader since the sound that a letter makes is often phonetically different from the letter's name. For example, if a student attempted to read the word “bird” knowing only letter names, the student would pronounce the word as “bē”-“ī”-“ar” -“dē” (“bēīardē”). In the method of the present invention, students should have the letter-sound knowledge in place before learning the letters' names.

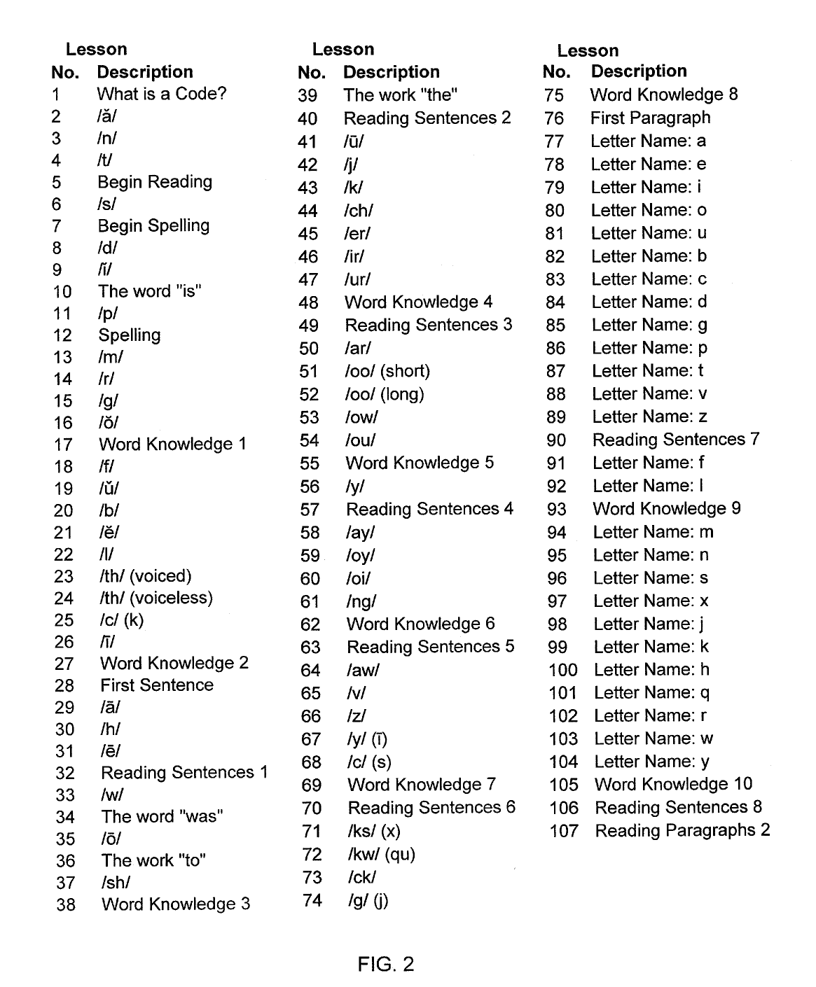

The method may be used to teach English to young children who are learning English as their first language or to individuals who may be learning English as a secondary language. The method can be organized into a curriculum of activities or lessons, which are intended to be presented at the rate of one lesson per day. The lessons may range between approximately 10 and 30 minutes in length. In one embodiment, the curriculum is organized into approximately 100 lessons as shown in FIG. 2. Each lesson contains a specific reading, spelling, or comprehensive review concept. Each lesson may be comprised of separate segments including whole group instruction, individual practice, small group instruction and homework. During the curriculum, students progress from learning basic phonemes to reading paragraphs.

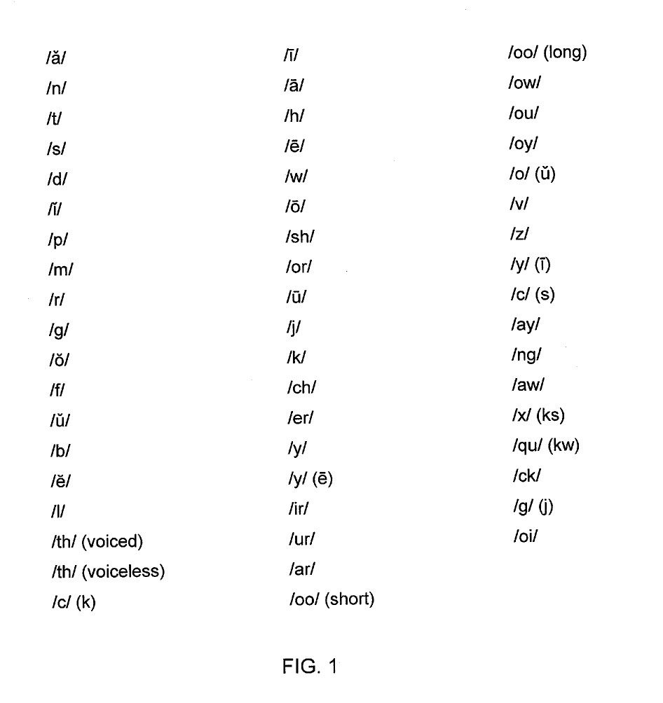

FIG. 1 shows a list of phonemes that are presented to the students in one embodiment of the method. While these phonemes may be presented to the students in any order, the phonemes most commonly occurring in the English language may optionally be presented before the phonemes which may be less commonly occurring. Likewise, the phonemes having the most utility in building words may optionally be presented before the phonemes having lesser utility.

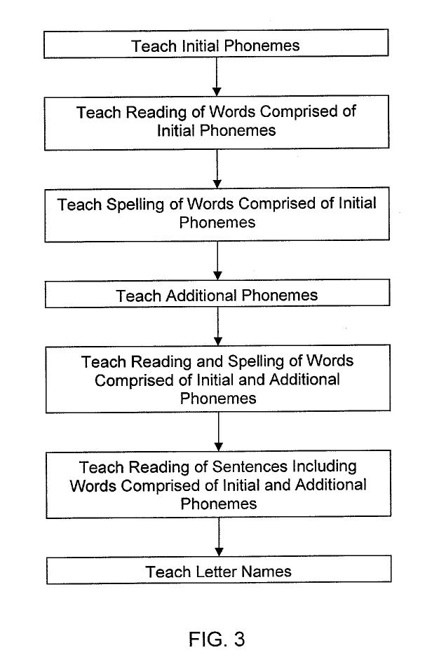

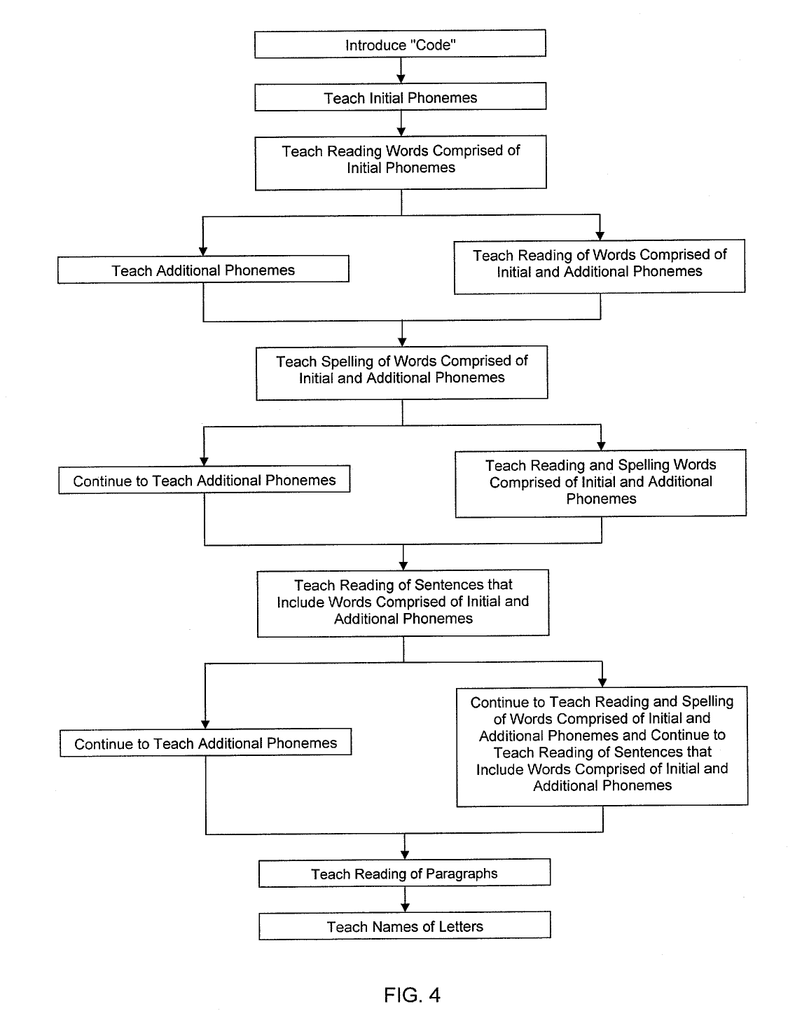

FIG. 3 illustrates the basic steps that are undertaken in one embodiment of the method and FIG. 4 provides a more detailed set of steps that are preformed in another embodiment of the method. As shown in FIG. 4, the first step is to introduce the students to the curriculum and convey to them that the written form of the English language is simply a “code” and that his or her task is to learn how to decipher or crack the code. This can be accomplished in a single lesson. During that lesson, the students are told that learning to read and spell is essentially discovering how to use the code.

The method treats reading as a process in which the letters that comprise a word are “decoded” into their respective sounds. Likewise, the method treats spelling as a process in which the sounds of a word are “encoded” into their respective letters. Historically, reading and spelling have been two skills that have been taught independently of each other. However, under these circumstances, the students do not come to appreciate the reciprocal nature of reading and spelling. In order for students to completely comprehend the code, the students not only use the code to determine the message that the code represents, but also to create messages based on the code. Reading and spelling are two related processes that need to be mastered to fully engage in the written form of the language.

Next, the students are presented with a set of initial phonemes. In one embodiment, the curriculum of lessons is designed such that no more than one phoneme is presented per lesson. As mentioned above, the phonemes may be presented in an order such that the phonemes that are most commonly encountered and the phonemes having the greatest utility in building words are presented first. For example, in one embodiment, the /\check{a}/, /n/, and /t/ phonemes are presented first.

In presenting each phoneme to the students, the instructor may first orally pronounce the phoneme and then have the students repeat the phoneme back. Simultaneous with pronouncing the phoneme, the instructor can present the students with the letter associated with the phoneme. This can be done by displaying the letter on a medium, such as a card, poster, chalk board, computer screen, projection screen or the like. Alternatively, the letter may be displayed in the form of a cut out. When presenting the letter, the instructor may present both the lower case and upper case versions of the letter.

While presenting the phoneme, the instructor may also give examples of simple words in which the phoneme occurs. For example, when teaching the /\check{a}/ phoneme, the instructor may provide the examples of “ant,” “map,” “grass,” “apple,” “alligator,” “astronaut,” and “castle.” When providing the examples, the instructor may place a special emphasis on the /\check{a}/ phoneme. Additionally, the instructor may present the students with objects or images of objects whose names contain the phoneme. These objects may be the same objects that are given as examples (e.g., map, apple, castle, etc.).

While the students are repeating the phoneme and practicing its pronunciation, they can be instructed to feel their throats for any vibrations that may occur when they are pronouncing the phoneme. Sounds are pronounced as either voiced or voiceless. Voicing refers to the vibrations that occur in the vocal cords. The “voiced” sounds can be felt by placing the fingers next to the vocal cords and feeling for the vibrations as the sound is pronounced. For example, the “zzz” sound is a voiced sound, whereas the “sss” sound is a voiceless sound. Having the students feel their throats for vibrations will help ensure that the students are pronouncing the phoneme correctly.

Additionally, writing may also be incorporated into the method of the present invention. After having seen the letter, the students may be instructed to write the letter. They may optionally be required to write both the upper case and lower case versions of the letter. In one embodiment, the students are provided a worksheet that includes a diagram showing the proper way to write the letter, for example, the order in which their pencil strokes should be made. While writing each letter, the students can be required to say the phoneme associated with that letter out loud. It has been found that students learn letter-sound correspondence most efficiently by writing the letters while voicing the phoneme that the letter represents.

Further, each student may be given a card or other medium having each letter displayed thereon. As described below, these cards are used to teach spelling.

Once the students have been presented with enough phonemes to form a word, the students are presented with a word or words incorporating those phonemes. For example, after the students have been presented with the /\check{a}/, /n/, and /t/ phonemes, the students may be presented and taught to read words such as “ant,” “tan,” “at,” and “an.” In doing so, the students are taught to “blend” or synthesize the phonemes together to form a word. The instructor will first point to each of the letters individually and pronounce the phonemes associated with the letters, leaving some separation between each of the phonemes (e.g., /\check{a}/ - - - /n/ - - - /t/). Next, the instructor will repeat the phonemes with less separation between them (e.g., /\check{a}/-/n/-/t/). Then, the instructor will repeat the phonemes blending them together into a word (e.g., ant). After that, the students will be asked to repeat this same process of blending the phonemes into a word.

Upon the students having learned how to read a few words incorporating the initial set of phonemes, the students may be introduced to spelling. While reading requires deciphering the written code into its auditory representations, spelling requires determining the written code that represents particular sounds. In the method, students are introduced to the correlation between reading and spelling.

As mentioned above, during the lessons introducing each of the phonemes, the students may be presented with cards or other media, each having the letter associated with the respective phoneme displayed thereon. These letter cards are used during the spelling lessons. Because the students have not yet been taught the names of the letters, they are unable to verbally articulate the spelling of the words. Instead, the students use the cards to spell the words. Alternatively, the students may spell words by writing or typing them.

In teaching the students to spell, the teacher may first say a word and then ask the students to arrange their letter cards in order to spell the word. For example, if the students have been presented with the /\check{a}/, /n/, /t/, and /s/ phonemes and the teacher says the word “ants,” the students will place the “a” card, the “n” card, the “t” card, and the “s” card in order to spell the word. Since the students already know the phonemes associated with each of those four letters, they can be instructed to place the letter cards in the order that they hear the respective phonemes when the teacher pronounces the word. In this example, the students may also be asked to spell other works incorporating the phonemes that they have been taught, including “ant,” “that,” “ants,” “tan,” “tans,” “at,” and “an.”

As depicted in FIG. 4, the next steps of the method involve teaching the students additional phonemes and teaching them to read words incorporating those phonemes as well as the phonemes that were taught initially. These steps may take place generally simultaneously with one another or in a proximate series of lessons. The step of teaching the additional phonemes is undertaken in the same general manner as the step of teaching the initial phonemes. Likewise, the step of teaching the students to read words that are comprised of the additional phonemes is undertaken in the same general manner as the step of teaching the reading of words comprised solely of the initial phonemes.

Next, the students may be taught how to spell words comprised of the additional and initial phonemes. Again, this step is undertaken in the same general manner as the step of teaching the students to spell words comprised solely of the initial phonemes.

As depicted in FIG. 2, additional phonemes are continually taught to the students as the curriculum progresses. The students are also taught to read and spell words containing the newly-learned phonemes. After the students have been taught to read several words, those words are put together in the form of a sentence and the students are introduced to reading sentences. The primary purpose of the lessons focusing on the reading of sentences is to build reading fluency and to continue to develop the students' decoding skills if they are not able to read a word instantly.

As the curriculum continues, the presentation of additional phonemes continues, as does the teaching of how to read and spell additional words and sentences incorporating those phonemes. Not only do the students learn how to read sentences, but the method can also contain lessons focused on the reading of paragraphs. The goal of these lessons is to continue to develop reading fluency and decoding skills as well as comprehension.

Several of the lessons in the curriculum do not teach new material, but rather review the material taught in prior lessons. The primary purpose of these lessons is to build the students' site reading skills. If they do not recognize a word, they are instructed to use the “code” to decode the word into its sounds and then synthesize those sounds into a word, which they should recognize.

The method may also incorporate assessments each week and month. These are used to monitor the progress of the students so that the instructor can adjust the activities accordingly. If there are differences between the students' abilities, this can be addressed in small group instruction sessions.

After substantially all of the phonemes in the curriculum have been presented, the names of the letters may be presented. Fundamental to the method is the fact that the names of the letters are not presented to the students until they have an understanding of the phonemes associated with each letter. Up to this point, the letter names have been withheld from the students and any student with knowledge of the letter names is encouraged not to use the letter name. Again, the letter names are not taught until this later stage because letter name knowledge can confuse the beginning reader since the sound that a letter makes is often phonetically different from the letter's name.

It is within the scope of the invention to incorporate the method into a computer program. The computer program, through the use of a storage medium and processor, would in a sense replace some or substantially all of the actions of the instructor in undertaking some or substantially all of the steps described above and set forth in FIGS. 3 and 4.

From the foregoing, it may be seen that the method of the present invention is particularly well suited for the proposed usages thereof. Furthermore, since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

What is claimed is:

1. A method of teaching reading, comprising the steps of:
presenting a first letter displayed on a medium to a student and associating a first phoneme with said first letter;
presenting a second letter displayed on a medium to the student and associating a second phoneme with said second letter;
presenting the student with at least one word that incorporates said first and second phonemes;
instructing the student to read said at least one word by blending said first and second phonemes; and
presenting names of said first and second letters to the student after the student has learned the phonemes associated with said first and second letters.

2. The method of claim 1 further comprising the step of providing the student with at least two cards, each card having one of said first and second letters displayed thereon.

3. The method of claim 2 further comprising the step of instructing the student to spell said at least one word by arranging said cards.

4. The method of claim 1 further comprising the step of presenting the student with a first object whose name contains said first phoneme and a second object whose name contains said second phoneme.

5. The method of claim 4 wherein the names of said first and second objects are pronounced orally to the student with an emphasis placed on said first and second phonemes.

6. The method of claim 1 further comprising the step of presenting the student with both upper case and lower case versions of said first and second letters.

7. The method of claim 1 further comprising the step of pronouncing said first and second phonemes orally to the student and having the student repeat the pronunciations of said first and second phonemes.

8. The method of claim 7 further comprising the step of instructing the student to feel the student's throat for vibrations when repeating the pronunciations of said first and second phonemes.

9. The method of claim 1 further comprising the step of instructing the student to write one of said first and second letters and while writing one of said first and second letters simultaneously repeating a phoneme associated with the letter being written.

10. The method of claim 1 wherein said method is divided between a plurality of separate lessons.

11. The method of claim 10 wherein the student is not presented with more than one phoneme per lesson.

12. The method of claim 10 wherein said lessons are broken into segments including whole group instruction, individual practice, small group instruction and homework.

13. The method of claim 10 wherein all of said lessons are contained in a single curriculum.

14. The method of claim 1 further comprising the initial step of instructing the student that learning to read can be accomplished by learning how to decipher a code.

15. A method of teaching reading and spelling, comprising the steps of:
presenting a student with at least two letters and associating a phoneme with each of said letters;
providing the student with a plurality of medium, each having one of said letters displayed thereon;
presenting the student with at least one word incorporating said phonemes;
instructing the student to read said word by synthesizing said phonemes into said word;
instructing the student to spell said word by arranging said medium with said letters displayed thereon; and
presenting names of said at least two letters to the student after the student has learned the phonemes associated with said letters.

16. A method of transforming a generally illiterate person into a person having a basic understanding of reading and writing the English language, said method comprising the steps of:
teaching the person at least a portion of phonemes encountered in the English language and associating letters with said phonemes;
teaching the person to read words comprised of said phonemes by blending two or more of said phonemes;
teaching the person to spell words comprised of said phonemes by separating said words into their respective phonemes and associating each phoneme with its respective letter.
teaching the person to read sentences that include words comprised of said phonemes;
teaching the person names of said letters.

17. The method of claim 16 wherein the person is taught phonemes most frequently encountered in the English language first before being taught phonemes least frequently encountered in the English language.

18. The method of claim 17 wherein the person is taught to read words comprised of said most frequently encountered phonemes before being taught said least frequently encountered phonemes.

19. The method of claim 18 wherein the person is taught to spell words comprised of said most frequently encountered phonemes before being taught said least frequently encountered phonemes.

20. The method of claim 16 wherein the step of teaching the person the names of said letters is not performed until said person has been taught substantially all of the phonemes associated with said letters.
